(19) United States
(12) Patent Application Publication
(10) Pub. No.: US 2019/0244323 A1
(43) Pub. Date: Aug. 8, 2019

(54) Pipelining and Concurrency Techniques for Groups of Graphics Processing Work

(71) Applicant: Apple Inc., Cupertino, CA (US)

(72) Inventors: Benjiman L. Goodman, Cedar Park, TX (US); Christopher L. Spencer, Chuluota, FL (US); Mark D. Earl, Oviedo, FL (US); Robert S. Hartog, Windemere, FL (US); Timothy M. Kelley, Orlando, FL (US)

(21) Appl. No.: 15/887,547

(22) Filed: Feb. 2, 2018

(51) Int. Cl. G06T 1/20; G06F 9/30; G06F 9/38

(52) U.S. Cl. CPC G06T 1/20; G06F 9/3867; G06F 9/30101

(57) ABSTRACT

Techniques are disclosed relating to processing groups of graphics work (which may be referred to as “kicks”) using a graphics processing pipeline. In some embodiments, a graphics processor includes multiple sets of configuration registers such that multiple kicks can be processed in the pipeline at the same time. In some embodiments, kicks are pipelined such that a subsequent kick ramps up use of hardware resources as a previous kick winds down. In some embodiments, the graphics processing may execute kicks concurrently and/or preemptively, e.g., based on a priority scheme. In some embodiments, the disclosed techniques may be used with pipelines that include front and back-end fixed function circuitry as well as shared programmable resources such as shader cores. In various embodiments, the disclosed techniques may improve overall performance and/or reduce latency for high-priority graphics tasks.

### BACKGROUND

### Technical Field

This disclosure relates generally to graphics processors and more specifically to techniques for processing groups of graphics work in a pipelined manner.

### Description of the Related Art

Graphics processing work is often formed into groups that are scheduled by graphics firmware for execution. Each group may be associated with state information, shader programs to execute, buffer information, texture data, address spaces, etc. that are needed to complete the work. Groups may be formed for different types of graphics work, such as compute tasks, fragment processing, or vertex processing, for example. These groups may be referred to as “kicks.” Multiple kicks may be executed to render a frame of graphics data, for example. Typically, graphics firmware programs configuration registers for each kick before sending the work to the pipeline for processing. Often, once a kick has started, it does not access a memory hierarchy above a certain level until the kick is finished (at which point results may be written to a higher level in the hierarchy).

With one set of configuration registers, a given kick must complete before the configuration registers for the pipeline can be updated for another kick. This may result in intervals where the graphics pipeline is not utilized. Further, higher-priority work may have to wait for prior kicks to finish before starting execution.

### BRIEF DESCRIPTION OF THE DRAWINGS

FIG. 1A is a block diagram illustrating an exemplary graphics processing flow.

FIG. 1B is a block diagram illustrating one embodiment of a graphics unit.

FIG. 2 is a block diagram illustrating an exemplary pipeline which front and back pipeline portions and a shared resource, according to some embodiments.

FIG. 3A is a diagram illustrating exemplary hardware utilization without pipelining of kicks, according to some embodiments.

FIG. 3B is a diagram illustrating exemplary hardware utilization with pipelined kicks, according to some embodiments.

FIG. 3C is a diagram illustrating exemplary hardware utilization with concurrent kick execution, according to some embodiments.

FIG. 3D is a diagram illustrating exemplary hardware utilization with preemptive kick execution, according to some embodiments.

FIG. 4 is a diagram illustrating exemplary kick execution for multiple data masters, according to some embodiments.

FIG. 5 is a diagram illustrating exemplary graphics pipeline circuitry for multiple data masters, according to some embodiments.

FIG. 6 is a diagram illustrating exemplary data from different kicks in portions of a pipeline, according to some embodiments.

FIG. 7 is a flow diagram illustrating an exemplary method for pipelining kicks, according to some embodiments.

FIG. 8 is a block diagram illustrating one embodiment of a device that includes a graphics unit.

FIG. 9 is a block diagram illustrating an exemplary computer-readable medium, according to some embodiments.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “shader pipeline configured to process graphics data” is intended to cover, for example, a circuit that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

Further, as used herein, the terms “first,” “second,” “third,” etc. do not necessarily imply an ordering (e.g., temporal) between elements. For example, a referring to a “first” graphics operation and a “second” graphics operation does not imply an ordering of the graphics operation, absent additional language constraining the temporal relationship between these operations. In short, references such as “first,” “second,” etc. are used as labels for ease of reference in the description and the appended claims.

### DETAILED DESCRIPTION

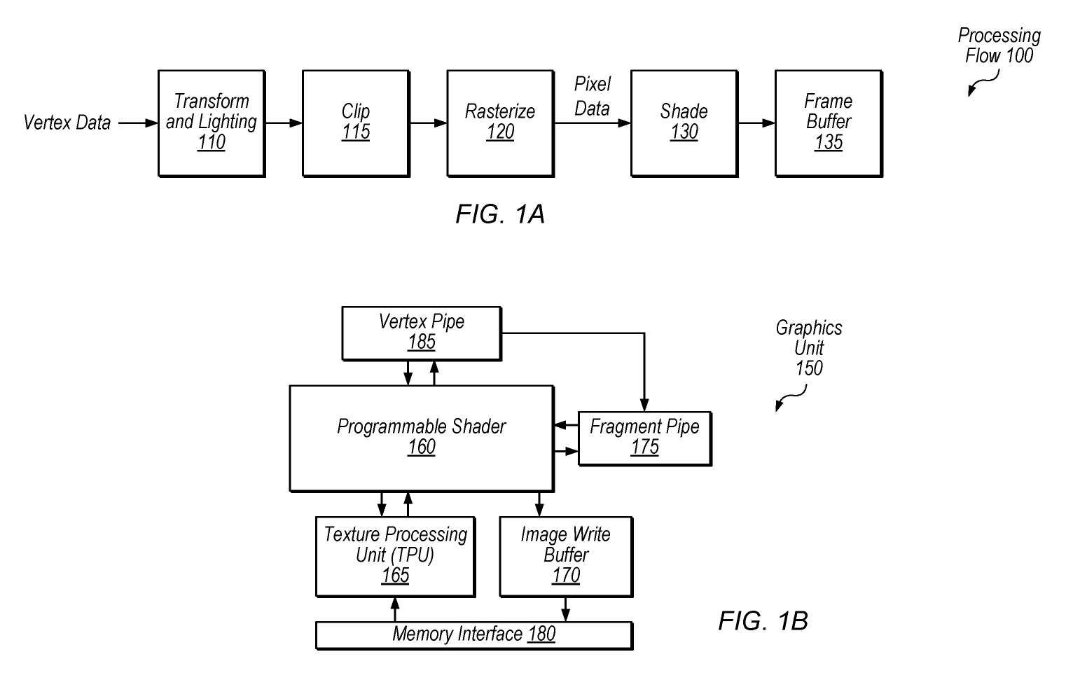

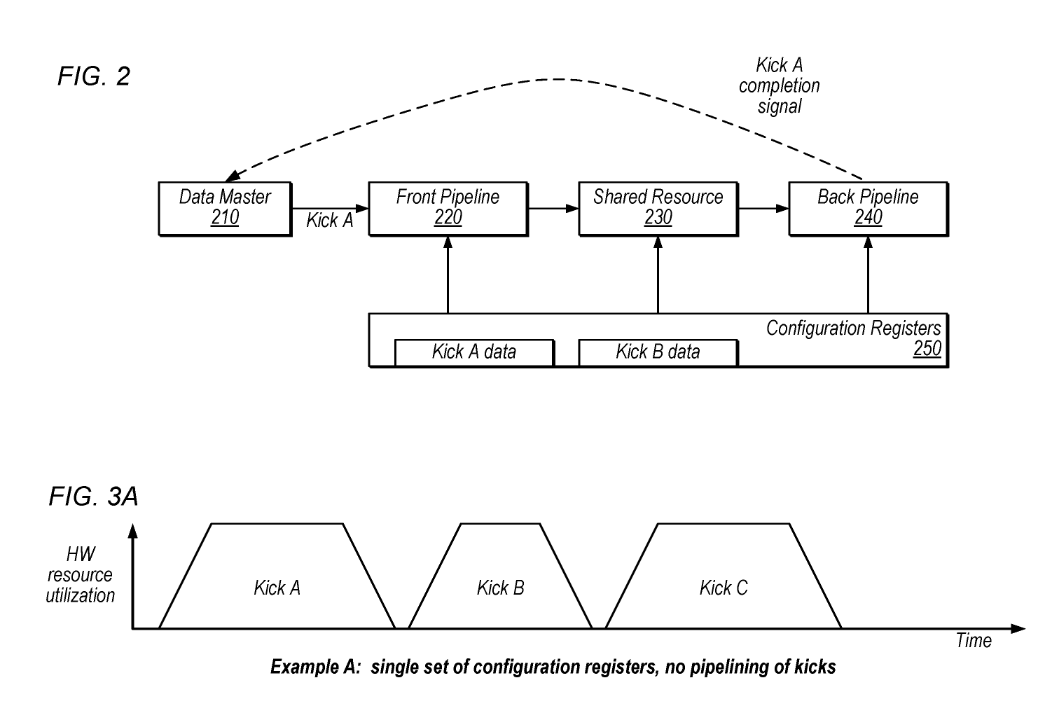

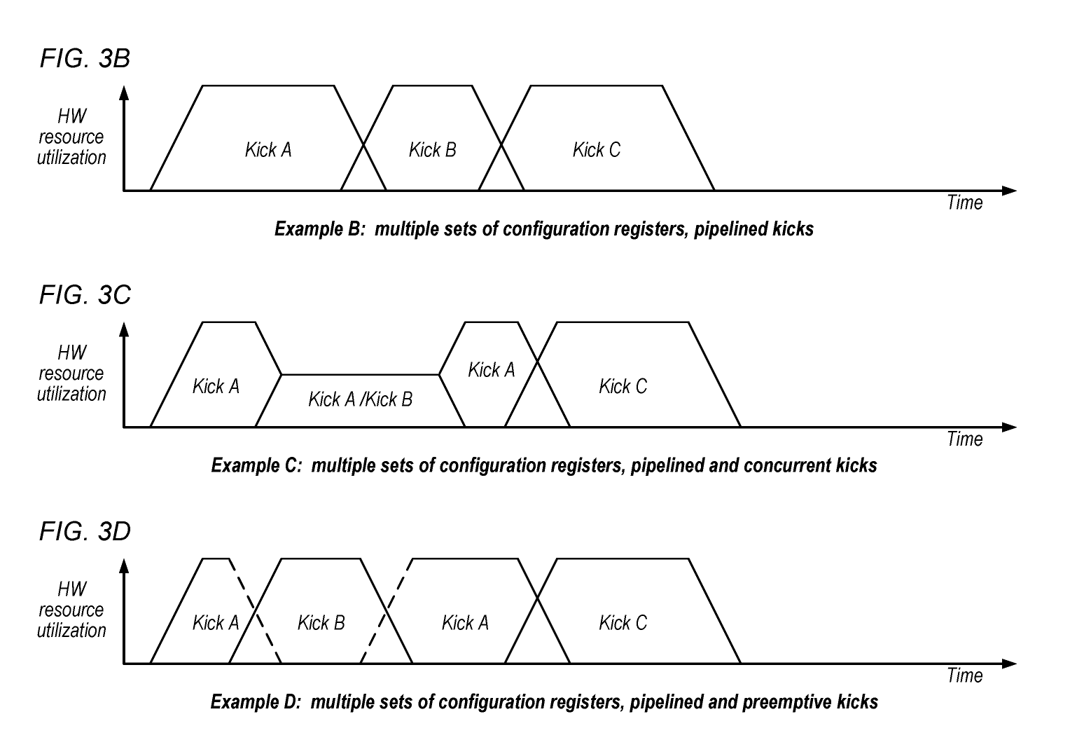

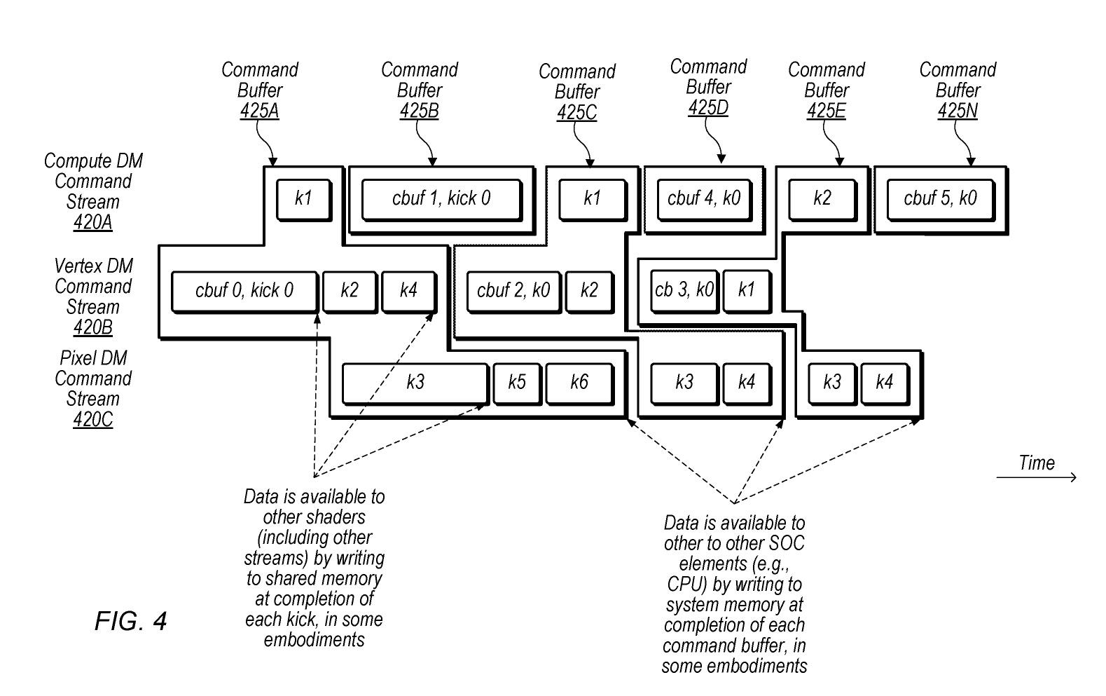

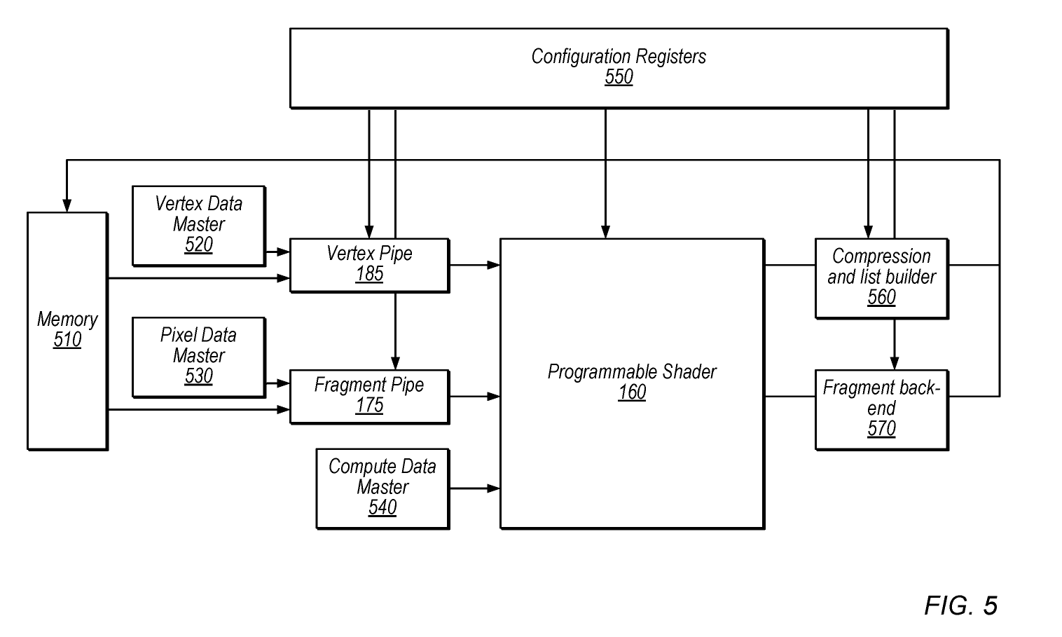

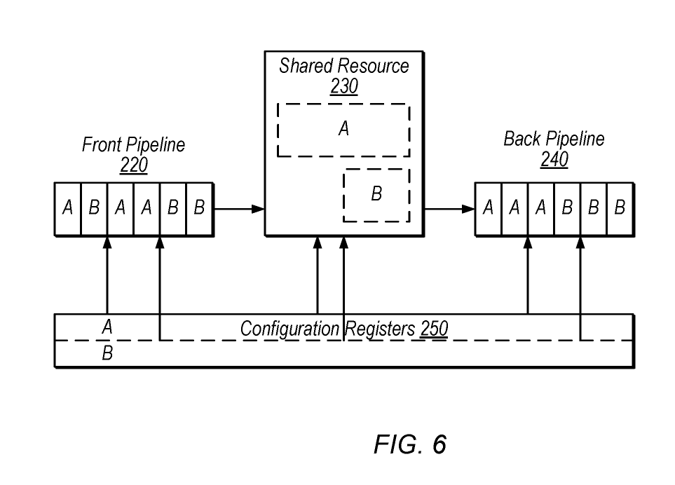

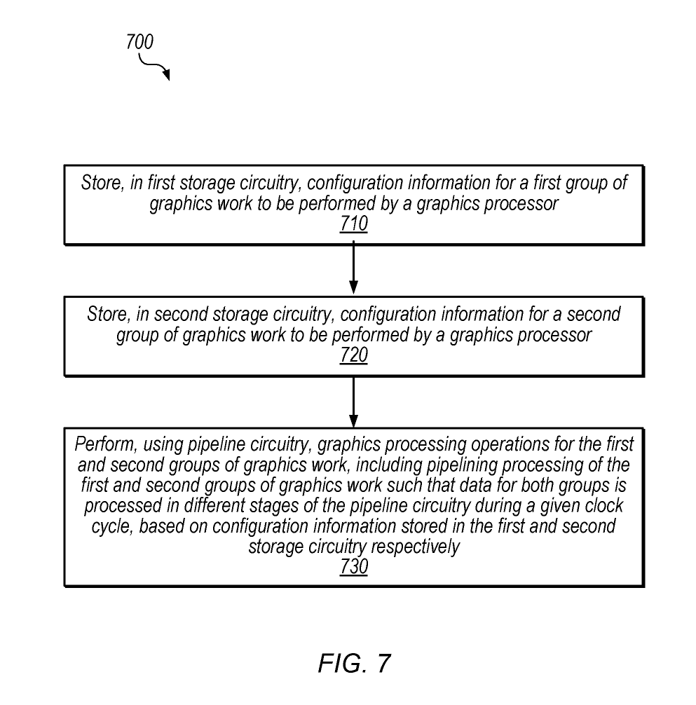

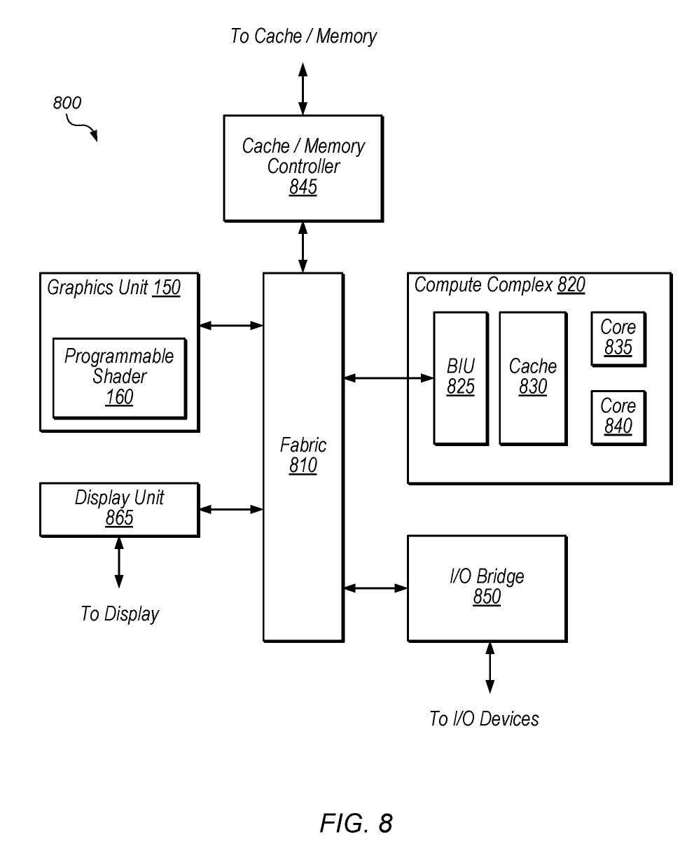

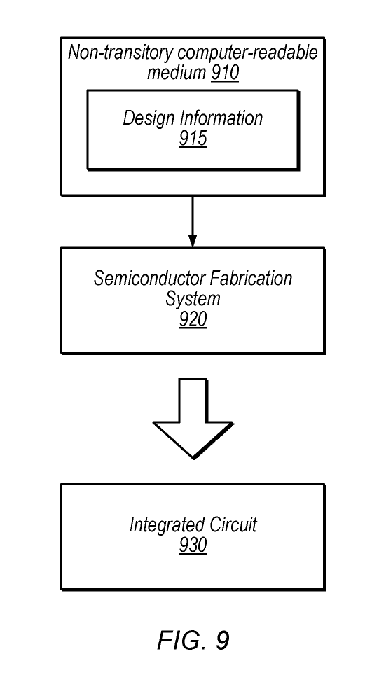

This disclosure initially describes, with reference to FIGS. 1A-1B, a generalized overview of a graphics processing flow and an exemplary graphics unit. FIG. 2 illustrates an exemplary graphics pipeline, FIGS. 3A-3D illustrate exemplary kick processing techniques that include pipelining, preemption, and concurrency, FIG. 4 illustrates kick execution for different data masters, FIG. 5 illustrates a pipeline with multiple data masters, and FIG. 6 illustrates exemplary data for different kicks in a pipeline. FIG. 7 illustrates an exemplary method, FIG. 8 illustrates an exemplary device, and FIG. 9 illustrates an exemplary computer-readable medium. In various embodiments, the disclosed techniques may improve performance of a graphics processor, including reducing latency for high-priority tasks in embodiments with concurrent or preemptive execution.

### Graphics Processing Overview

Referring to FIG. 1A, a flow diagram illustrating an exemplary processing flow 100 for processing graphics data is shown. In one embodiment, transform and lighting step 110 may involve processing lighting information for vertices received from an application based on defined light source locations, reflectance, etc., assembling the vertices into polygons (e.g., triangles), and/or transforming the polygons to the correct size and orientation based on position in a three-dimensional space. Clip step 115 may involve discarding polygons or vertices that fall outside of a viewable area. Rasterize step 120 may involve defining fragments within each polygon and assigning initial color values for each fragment, e.g., based on texture coordinates of the vertices of the polygon. Fragments may specify attributes for pixels which they overlap, but the actual pixel attributes may be determined based on combining multiple fragments (e.g., in a frame buffer) and/or ignoring one or more fragments (e.g., if they are covered by other objects). Shade step 130 may involve altering pixel components based on lighting, shadows, bump mapping, translucency, etc. Shaded pixels may be assembled in a frame buffer 135. Modern GPUs typically include programmable shaders that allow customization of shading and other processing steps by application developers. Thus, in various embodiments, the exemplary steps of FIG. 1A may be performed in various orders, performed in parallel, or omitted. Additional processing steps may also be implemented.

Referring now to FIG. 1B, a simplified block diagram illustrating one embodiment of a graphics unit 150 is shown. In the illustrated embodiment, graphics unit 150 includes programmable shader 160, vertex pipe 185, fragment pipe 175, texture processing unit (TPU) 165, image write unit 170, and memory interface 180. In some embodiments, graphics unit 150 is configured to process both vertex and fragment data using programmable shader 160, which may be configured to process graphics data in parallel using multiple execution pipelines or instances.

Vertex pipe 185, in the illustrated embodiment, may include various fixed-function hardware configured to process vertex data. Vertex pipe 185 may be configured to communicate with programmable shader 160 in order to coordinate vertex processing. In the illustrated embodiment, vertex pipe 185 is configured to send processed data to fragment pipe 175 and/or programmable shader 160 for further processing.

Fragment pipe 175, in the illustrated embodiment, may include various fixed-function hardware configured to process pixel data. Fragment pipe 175 may be configured to communicate with programmable shader 160 in order to coordinate fragment processing. Fragment pipe 175 may be configured to perform rasterization on polygons from vertex pipe 185 and/or programmable shader 160 to generate fragment data. Vertex pipe 185 and/or fragment pipe 175 may be coupled to memory interface 180 (coupling not shown) in order to access graphics data.

Programmable shader 160, in the illustrated embodiment, is configured to receive vertex data from vertex pipe 185 and fragment data from fragment pipe 175 and/or TPU 165. Programmable shader 160 may be configured to perform vertex processing tasks on vertex data which may include various transformations and/or adjustments of vertex data. Programmable shader 160, in the illustrated embodiment, is also configured to perform fragment processing tasks on pixel data such as texturing and shading, for example. Programmable shader 160 may include multiple execution instances for processing data in parallel.

TPU 165, in the illustrated embodiment, is configured to schedule fragment processing tasks from programmable shader 160. In some embodiments, TPU 165 is configured to pre-fetch texture data and assign initial colors to fragments for further processing by programmable shader 160 (e.g., via memory interface 180). TPU 165 may be configured to provide fragment components in normalized integer formats or floating-point formats, for example. In some embodiments, TPU 165 is configured to provide fragments in groups of four (a “fragment quad”) in a 2×2 format to be processed by a group of four execution pipelines in programmable shader 160.

Image write unit (IWU) 170, in some embodiments, is configured to store processed tiles of an image and may perform operations to a rendered image before it is transferred for display or to memory for storage. In some embodiments, graphics unit 150 is configured to perform tile-based deferred rendering (TBDR). In tile-based rendering, different portions of the screen space (e.g., squares or rectangles of pixels) may be processed separately. Memory interface 180 may facilitate communications with one or more of various memory hierarchies in various embodiments.

In various embodiments, a programmable shader such as programmable shader 160 may be coupled in any of various appropriate configurations to other programmable and/or fixed-function elements in a graphics unit. The exemplary embodiment of FIG. 1B shows one possible configuration of a graphics unit 150 for illustrative purposes.

### Overview of a Graphics Pipeline

In some embodiments, graphics unit 150 is configured to divide graphics processing work into kicks and configuration registers included in graphics unit 150 are programmed for each kick and used to perform graphics operations. Information for a given kick may include state information, location of shader programs to execute, buffer information, location of texture data, available address spaces, etc. that are needed to complete the corresponding graphics operations. Graphics firmware may schedule kicks and detect an interrupt when a kick is complete, for example.

FIG. 2 is a block diagram illustrating an exemplary graphics pipeline that includes a front pipeline 220, shared resource 230, and back pipeline 240. While this topology is shown for purposes of illustration, it is not intended to limit the scope of the present disclosure. In some embodiments, front pipeline 220 correspond to vertex pipe 185 or fragment pipe 175 and shared resource 230 corresponds to programmable shader 160. In some embodiments, back pipeline 240 may further process data, e.g., MSAA operations for fragment processing or compression of vertex information and list building (of vertices that intersect tiles) for tile-based vertex processing. In the illustrated embodiment, data master 210 sends work for a kick (kick A in the illustrated example) to the pipeline and receives a completion signal when kick A is complete.

In the illustrated embodiment, front pipeline 220, back pipeline 240, and/or shared resource 230 perform graphics operations based on information in configuration registers 250. In other embodiments, only a portion of the pipeline may utilize configuration registers 250. In some embodiments, configuration registers 250 include multiple sets of registers configured to store information for multiple kicks at the same time. In the illustrated example, configuration registers 250 include data for both kick A and kick B. In various embodiments, this may facilitate pipelining and/or preemption of kicks, which may improve performance relative to implementations with registers for only one kick at a time.

The concept of a “pipeline” is well understood, and refers to the concept of splitting the “work” a processor performs on instructions into multiple stages. In CPUs, for example, these stages may include instruction decode, dispatch, execution, and retirement. In graphics units, these stages may include various operations for graphics elements such as vertices or fragments. For example, if front pipeline 220 is configured to process fragment data, it may include stages for fetching parameters, rasterization, depth and/or stencil tests, tag buffer allocation, etc. Many different pipeline architectures are possible with varying orderings of elements/portions. Various pipeline stages perform such steps on an instruction during one or more processor clock cycles, then pass the instruction and/or operations associated with the instruction on to other stages for further processing.

Further, the term “pipeline” may be used to refer to an entire pipeline structure (which may include shared hardware resources) or a portion thereof. For example, the circuitry in FIG. 2 may be referred to as a pipeline that includes front pipeline 220, shared resource 230, and back pipeline 240. Shared resource 230 itself may include various shader pipelines as well, for example. Thus, the term “pipeline” may refer to the entirety of a particular pipeline structure or to a portion thereof that includes two or more stages.

Hardware Utilization with Exemplary Kick Processing Techniques

FIG. 3A is a diagram illustrating exemplary hardware resource utilization over time for execution of three kicks A, B, and C without pipelining. In the illustrated embodiment, one kick must complete before the next can begin. Further, hardware resource utilization may ramp up at the beginning of each kick and ramp down at the end of each kick, e.g., as the kick begins to fill the pipeline and then drains the pipeline as it finishes.

In contrast, FIG. 3B is a diagram illustrating exemplary hardware resource utilization over time for execution of three kicks A, B, and C with pipelining (e.g., using multiple sets of configuration registers). In the illustrated example, kick B begins utilizing the pipeline before kick A is completed. This may reduce kick-to-kick timing overhead in various embodiments. The multiple sets of configuration registers may allow both kick A and kick B to have work in the pipeline without losing state information, for example. As shown, hardware resource utilization may be increased relative to the example of FIG. 3A and the overall processing time for kicks A, B, and C may be reduced.

In some embodiments, the graphics unit or the graphics program is configured to determine whether there are dependencies between kicks. In these embodiments, a kick that depends on a previous kick may not be pipelined with the previous kick (rather, the previous kick should complete execution before start of the subsequent, dependent kick). In some embodiments, barrier operations may be used to handle dependencies between kicks. For example, a barrier may be used to specify that a prior kick must reach a certain execution point before starting a second kick. There may be different indicators for barrier status, such as complete, complete and fenced, complete and written to memory, etc.

In some embodiments, using multiple sets of configuration registers may also allow concurrent use of hardware resources by multiple kicks. For example, one kick may at least partially use of hardware resources previously-assigned another kick.

FIG. 3C is a diagram illustrating exemplary hardware resource utilization over time for execution of three kicks A, B, and C with concurrent execution of kicks A and B. In the illustrated embodiment, in response to kick B beginning to use hardware resources, kick A is allocated a smaller share of resources until kick B is completed. The concurrent execution may be performed by the data master in interleaving work sent to the pipeline, for example. For example, the data master may send work for kick A for 10 cycles, then work for kick B for 10 cycles, then work for kick A, and so on. For shared hardware resources, both kicks being executed concurrently may execute in parallel using different portions of the shared hardware resource.

In FIG. 3D, kick B completely preempts kick A for at least a portion of its execution (although, in the illustrated example, kick A retains some hardware resources while kick B is ramping up and down). In some embodiments, preemption may substantially reduce latency for high-priority work.

In some embodiments, preemption may be handled based on priority. In some embodiments, a single bit may be used to indicate higher-priority kicks. In other embodiments, multiple priority levels may be implemented. As discussed above, higher-priority kicks may completely preempt lower-priority kicks during certain time intervals or may commandeer only a portion of their hardware resources for certain time intervals. In other embodiments, allocation information associated with a kick may explicitly indicate an amount of hardware allocated to a kick. If such a kick is a higher-priority kick, it may receive all of its allocated resources while remaining resources may be used by one or more lower-priority kicks, which may not receive their full allocation until higher-priority kicks have finished.

Note that, in some embodiments, the techniques illustrated in FIGS. 3C and 3D may not process kicks A, B, and C as quickly as if the kicks were simply pipelined in the order received, e.g., as in FIG. 3B. For example, switching between kicks may result in a cache warm-up interval. Concurrent execution (including complete preemption) may still be advantageous in various scenarios, however, such as when it is more important for kick B to finish in a timely fashion than for all three kicks to finish quickly.

Exemplary Kick Execution with Command Buffers and Multiple Data Masters

FIG. 4 is an exemplary diagram that shows execution of graphics command buffers 425A-425N, according to some embodiments. In the illustrated embodiment, command streams 420A-420C correspond to work assigned by different data masters (a compute data master, a vertex data master, and a pixel data master in this example). Other examples of data masters include, without limitation, a geometry shader data master and a tessellation data master. Each data master may handle scheduling of its corresponding work on portions of programmable shader 160. In some embodiments, one or more arbiters may select work from different data masters to shared resources such as programmable shader 160.

In some embodiments, pipelining and preemption of kicks is performed only among kicks from a particular data master. For example, in these embodiments pixel kicks may be pipelined and may preempt each other, but may not be pipelined with or preempt compute kicks. This may allow use of specialized circuitry for at least a portion of the pipeline for each data master.

In the illustrated embodiment, each command buffer 425 includes a set of one or more kicks. As shown a given command buffer may include kicks from multiple ones of the data masters 420. Further each data master may include multiple kicks in the same command buffer. For example, in the illustrated embodiment and with respect to “cbuf 0,” kick “k1” and kick “k2” are executed on command stream 420A and command stream 420B respectfully, yet the two kicks are grouped in a single command buffer “cbuf0.”

In some embodiments, a kick is an atomic unit of work from the view of other portions of graphics unit 150. Thus, in some embodiments, any data that is needed for a given kick is read from memory that is shared among multiple processing elements at the beginning of the kick and results are written back to shared memory at the end of the kick. Therefore, other hardware does not see the results of the kick until completion of the kick, at which point the results are available in shared memory and can be accessed by other kicks (including kicks from other data masters). A kick may include a set of one or more rendering commands, which may include a command to draw procedural geometry, a command to set a shadow sampling method, a command to draw meshes, a command to retrieve a texture, a command to perform generation computation, etc. A kick may be executed at one of various stages during the rendering of a frame. Examples of rendering stages include, without limitation: camera rendering, light rendering, projection, texturing, fragment shading, etc.

Exemplary Embodiment with Multiple Data Masters and Front/Back-End Circuitry

FIG. 5 is a block diagram illustrating a portion of graphics unit 150 in more detail, according to some embodiments. In the illustrated embodiment, graphics unit 150 includes programmable shader 160, fragment pipe 175, vertex pipe 185, memory 510, three data masters (vertex data master 520, pixel data master 530, and compute data master 540), configuration registers 550, compression and list builder 560, and fragment back-end circuitry 570. In the illustrated embodiments, certain types of kicks are discussed in detail, but similar techniques may be used for other types of kicks, in various embodiments.

Note that the fragment pipe 175 and the vertex pipe 185 are examples of the front pipeline circuitry 220 of FIG. 2 and the compression and list builder 560 is an example of the back pipeline circuitry 240 of FIG. 2.

For vertex kicks, in the illustrated embodiment, vertex data master 520 sends control information to vertex pipe 185 and retrieves input data for kicks from memory 510. Vertex pipe 185, in the illustrated embodiment, is fixed-function circuitry that processes the input data based on information in configuration registers 550. In some embodiments, vertex pipe 185 is configured to perform operations such as culling, clipping, viewport transformation, etc. In some embodiments, vertex pipe 185 may have data for different kicks in different stages of the pipe, using different sets of registers in configuration registers 550. Thus, the appropriate configuration register data for a given kick may be multiplexed into the pipeline stages processing that kick. In some embodiments, vertex pipe 185 does not allow concurrent execution of kicks within a given pipeline stage but may allow concurrent execution via interleaving. In embodiments with complete preemption, vertex pipe 185 may stop processing a lower priority kick and allow its data to empty from the pipeline (e.g., for further processing by programmable shader 160). In some embodiments that allow concurrent kicks, programmable shader 160 may allow parallel processing of multiple vertex kicks.

Note that programmable shader may also be performing tasks for other data masters. Therefore, vertex data master 520 may be assigned only a portion of the resources (e.g., a percentage of the shaders, memory resources, etc.) of programmable shader 160. In embodiments with concurrent kicks and/or preemption, vertex kicks may then contend for the resources assigned to vertex data master 520, e.g., based on their priority.

In the illustrated embodiment, compression and list builder 560 is configured for tile-based processing and is configured to compress vertex data from programmable shader 160 and build lists of vertices that intersect each tile. Compression may reduce memory requirements for memory 510. When the tiles are later processed (e.g., under the control of pixel data master for rasterization and shading) the lists may be accessed to determine which vertices should be fetched. In some embodiments, compression and list builder 560 is fixed-function circuitry (e.g., in contrast to programmable shader 160, which executes various graphics instructions). In the illustrated embodiment, compression and list builder circuitry 560 sends its output data back to memory 510, where it may be stored for further processing.

Pixel data master 530 similarly may send pixel kicks to fragment pipe 175 and then for further processing by programmable shader 160. In some embodiments, fragment pipe 175 is configured to perform rasterization and includes depth and stencil buffers configured to determine which fragments from rasterization are visible and should be shaded. In some embodiments, fragment pipe 175 includes a tag buffer for fragments being aggregated until they are sent to programmable shader 160. In some embodiments, programmable shader 160 is configured to shade pixels from fragment pipe 175. In some embodiments, multi-sample anti-aliasing (MSAA) hardware in fragment back-end circuitry 570 may further process shaded pixels from programmable shader 160 before storing pixel data in memory (e.g., for eventual display).

Compute data master 540, in the illustrated embodiment, is configured to send compute kicks (which may each include multiple kernels) to programmable shader 160. In various embodiments, the pipelining, concurrency, and preemption techniques discussed above with reference to vertex kicks may be performed for pixel and/or compute kicks.

### Exemplary Concurrent Execution of Kicks

FIG. 6 is a block diagram illustrating exemplary concurrent execution of kicks A and B using the hardware of FIG. 2, according to some embodiments. In the illustrated embodiment, configuration registers 250 store configuration information for both kick A and kick B. In the illustrated example situation, the front pipeline includes stages with data for kick A interleaved with data in stages for kick B. Each stage may use data from the appropriate configuration register, e.g., by pipelining an identifier of the kick and multiplexing the appropriate configuration register based on the identifier.

Shared resource 230, in the illustrated embodiment, includes a portion of its hardware resources assigned to kick A and a smaller portion to kick B. These portions may execute in parallel in some embodiments, e.g., using different shader cores. Back pipeline 240, in the illustrated embodiment, also includes different kick data in different stages, similarly to front pipeline 220.

### Exemplary Method

FIG. 7 is a flow diagram illustrating an exemplary method 700 for pipelining different groups of graphics word (e.g., kicks), according to some embodiments. The method shown in FIG. 7 may be used in conjunction with any of the computer systems, devices, elements, or components disclosed herein, among other devices. In various embodiments, some of the method elements shown may be performed concurrently, in a different order than shown, or may be omitted. Additional method elements may also be performed as desired.

At 710, in the illustrated embodiment, a graphics unit stores, in first storage circuitry, configuration information for a first group of graphics work to be performed by the graphics processor.

At 720, in the illustrated embodiment, the graphics unit stores, in second storage circuitry, configuration information for a second group of graphics work to be performed by the graphics processor.

At 730, in the illustrated embodiment, the graphics unit uses pipeline circuitry to perform graphics processing operations for the first and second groups of graphics work. In the illustrated embodiment, this includes pipelining processing of the first and second groups of graphics work such that data for both groups is processed in different stages of the pipeline circuitry during a given clock cycle. In the illustrated embodiment, during the clock cycle, the processing for the different stages is based on configuration information stored in the first and second storage circuitry respectively. For example, the method may include MUXing the configuration information to the proper pipeline stages.

In some embodiments, the second group is older than the first group (e.g., the second group may have been initiated by a graphics driver before initiation of the first group) and the first group has a higher priority than the second group. In some embodiments, and the graphics pipeline pauses processing for the second group until completion of the first group (note that stages for the second group may be allowed to complete after the pause, even in some preemption embodiments). In some embodiment, the graphics unit is configured to assign a first portion of a shared resource (e.g., programmable shader 160) to the first group and a second portion of the shared resource to the second group in response to determining that the first group has a higher priority than the second group. In some embodiments, the pipeline circuitry includes a front fixed-function portion, a programmable shader portion, and a back fixed-function portion. In some embodiments, the front fixed-function portion is configured to perform graphics processing based on configuration information in both the first storage circuitry and the second storage circuitry at the same time. In some embodiments, the configuration information includes one or more of: an indication of a location of a shader program, an indication of a location of a texture, an indication of a memory space, or state information.

In some embodiments, graphics firmware performs the following method elements. The firmware programs first storage circuitry and second storage circuitry with different sets of configuration information for different kicks. The firmware launches the kicks at a point in time when configuration for both kicks is stored in the different storage circuitry and data for both kicks is processed in different stages of the graphics pipeline during a given clock cycle, based on configuration information stored in the first and second storage circuitry respectively. In some embodiments the graphics firmware is stored on a computer-readable medium in the graphics unit.

### Exemplary Device

Referring now to FIG. 8, a block diagram illustrating an exemplary embodiment of a device 800 is shown. In some embodiments, elements of device 800 may be included within a system on a chip. In some embodiments, device 800 may be included in a mobile device, which may be battery-powered. Therefore, power consumption by device 800 may be an important design consideration. In the illustrated embodiment, device 800 includes fabric 810, compute complex 820 input/output (I/O) bridge 850, cache/memory controller 845, graphics unit 150, and display unit 865. In some embodiments, device 800 may include other components (not shown) in addition to and/or in place of the illustrated components, such as video processor encoders and decoders, image processing or recognition elements, computer vision elements, etc.

Fabric 810 may include various interconnects, buses, MUX's, controllers, etc., and may be configured to facilitate communication between various elements of device 800. In some embodiments, portions of fabric 810 may be configured to implement various different communication protocols. In other embodiments, fabric 810 may implement a single communication protocol and elements coupled to fabric 810 may convert from the single communication protocol to other communication protocols internally.

In the illustrated embodiment, compute complex 820 includes bus interface unit (BIU) 825, cache 830, and cores 835 and 840. In various embodiments, compute complex 820 may include various numbers of processors, processor cores and/or caches. For example, compute complex 820 may include 1, 2, or 4 processor cores, or any other suitable number. In one embodiment, cache 830 is a set associative L2 cache. In some embodiments, cores 835 and/or 840 may include internal instruction and/or data caches. In some embodiments, a coherency unit (not shown) in fabric 810, cache 830, or elsewhere in device 800 may be configured to maintain coherency between various caches of device 800. BIU 825 may be configured to manage communication between compute complex 820 and other elements of device 800. Processor cores such as cores 835 and 840 may be configured to execute instructions of a particular instruction set architecture (ISA) which may include operating system instructions and user application instructions.

Cache/memory controller 845 may be configured to manage transfer of data between fabric 810 and one or more caches and/or memories. For example, cache/memory controller 845 may be coupled to an L3 cache, which may in turn be coupled to a system memory. In other embodiments, cache/memory controller 845 may be directly coupled to a memory. In some embodiments, cache/memory controller 845 may include one or more internal caches.

As used herein, the term “coupled to” may indicate one or more connections between elements, and a coupling may include intervening elements. For example, in FIG. 8, graphics unit 150 may be described as “coupled to” a memory through fabric 810 and cache/memory controller 845. In contrast, in the illustrated embodiment of FIG. 8, graphics unit 150 is “directly coupled” to fabric 810 because there are no intervening elements.

Graphics unit 150 may include one or more processors and/or one or more graphics processing units (GPU's). Graphics unit 150 may receive graphics-oriented instructions, such as OPENGL®, Metal, or DIRECT3D® instructions, for example. Graphics unit 150 may execute specialized GPU instructions or perform other operations based on the received graphics-oriented instructions. Graphics unit 150 may generally be configured to process large blocks of data in parallel and may build images in a frame buffer for output to a display. Graphics unit 150 may include transform, lighting, triangle, and/or rendering engines in one or more graphics processing pipelines. Graphics unit 150 may output pixel information for display images. In some embodiments, graphics unit 150 is configured to perform one or more of the memory consistency, mid-render compute, local image block, and/or pixel resource synchronization techniques discussed above.

Display unit 865 may be configured to read data from a frame buffer and provide a stream of pixel values for display. Display unit 865 may be configured as a display pipeline in some embodiments. Additionally, display unit 865 may be configured to blend multiple frames to produce an output frame. Further, display unit 865 may include one or more interfaces (e.g., MIPI® or embedded display port (eDP)) for coupling to a user display (e.g., a touchscreen or an external display).

I/O bridge 850 may include various elements configured to implement: universal serial bus (USB) communications, security, audio, and/or low-power always-on functionality, for example. I/O bridge 850 may also include interfaces such as pulse-width modulation (PWM), general-purpose input/output (GPIO), serial peripheral interface (SPI), and/or inter-integrated circuit (I2C), for example. Various types of peripherals and devices may be coupled to device 800 via I/O bridge 850.

### Exemplary Computer-Readable Medium

The present disclosure has described various exemplary circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that is recognized by a fabrication system configured to produce hardware (e.g., an integrated circuit) that includes the disclosed circuitry. Claims to such a storage medium are intended to cover, for example, an entity that produces a circuit design, but does not itself fabricate the design.

FIG. 9 is a block diagram illustrating an exemplary non-transitory computer-readable storage medium that stores circuit design information, according to some embodiments. In the illustrated embodiment semiconductor fabrication system 920 is configured to process the design information 915 stored on non-transitory computer-readable medium 910 and fabricate integrated circuit 930 based on the design information 915.

Non-transitory computer-readable medium 910, may comprise any of various appropriate types of memory devices or storage devices. Medium 910 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Medium 910 may include other types of non-transitory memory as well or combinations thereof. Medium 910 may include two or more memory mediums which may reside in different locations, e.g., in different computer systems that are connected over a network.

Design information 915 may be specified using any of various appropriate computer languages, including hardware description languages such as, without limitation: VHDL, Verilog, SystemC, SystemVerilog, RHDL, M, MyHDL, etc. Design information 915 may be usable by semiconductor fabrication system 920 to fabricate at least a portion of integrated circuit 930. The format of design information 915 may be recognized by at least one semiconductor fabrication system 920. In some embodiments, design information 915 may also include one or more cell libraries which specify the synthesis and/or layout of integrated circuit 930. In some embodiments, the design information is specified in whole or in part in the form of a netlist that specifies cell library elements and their connectivity. Design information 915, taken alone, may or may not include sufficient information for fabrication of a corresponding integrated circuit. For example, design information 915 may specify the circuit elements to be fabricated but not their physical layout. In this case, design information 915 may need to be combined with layout information to actually fabricate the specified circuitry.

Semiconductor fabrication system 920 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 920 may also be configured to perform various testing of fabricated circuits for correct operation.

In various embodiments, integrated circuit 930 is configured to operate according to a circuit design specified by design information 915, which may include performing any of the functionality described herein. For example, integrated circuit 930 may include any of various elements shown in FIGS. 1B, 2, 5 and/or 6. Further, integrated circuit 930 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. An apparatus, comprising:
first storage circuitry and second storage circuitry configured to store configuration information for respective groups of graphics work to be performed by the apparatus, wherein the first and second storage circuitry is programmable by the apparatus before sending corresponding groups of graphics work to pipeline circuitry for processing;
pipeline circuitry configured to perform graphics processing operations on groups of graphics work based on configuration information stored in an indicated one of the first storage circuitry and the second storage circuitry;
wherein the apparatus is configured to simultaneously store configuration information for first and second groups of graphics work in the first and second storage circuitry respectively; and
wherein the pipeline circuitry is configured to pipeline processing of the first and second groups of graphics work such that data for both groups is processed in different stages of the pipeline circuitry during a given clock cycle, based on configuration information stored in the first and second storage circuitry respectively.

2. The apparatus of claim 1, wherein the second group is older than the first group, the first group has a higher priority than the second group, and the pipeline circuitry is configured to pause processing for the second group until completion of the first group.

3. The apparatus of claim 1, wherein the second group is older than the first group, the first group has a higher priority than the second group, and the pipeline circuitry includes a shared resource; and
wherein the apparatus is configured to assign a first portion of the shared resource to the first group and a second portion of the shared resource to the second group in response to determining that the first group has a higher priority than the second group.

4. The apparatus of claim 3, wherein the shared resource is a programmable shader.

5. The apparatus of claim 1, wherein the pipeline circuitry includes a front fixed-function portion, a programmable shader portion, and a back fixed-function portion.

6. The apparatus of claim 5, wherein the front fixed-function portion is configured to perform graphics processing based on configuration information in both the first storage circuitry and the second storage circuitry at the same time.

7. The apparatus of claim 1, wherein the configuration information includes one or more of: an indication of a location of a shader program, an indication of a location of a texture, an indication of a memory space, or state information.

8. A method, comprising:
storing, in first storage circuitry, configuration information for a first group of graphics work to be performed by a graphics processor;
storing, in second storage circuitry, configuration information for a second group of graphics work to be performed by the graphics processor; and
performing, by pipeline circuitry, graphics processing operations for the first and second groups of graphics work, including pipelining processing of the first and second groups of graphics work such that data for both groups is processed in different stages of the pipeline circuitry during a given clock cycle, based on configuration information stored in the first and second storage circuitry respectively.

9. The method of claim 8, wherein the second group is older than the first group, the first group has a higher priority than the second group, and the pipeline circuitry pauses processing for the second group until completion of the first group.

10. The method of claim 8, wherein the second group is older than the first group, the first group has a higher priority than the second group, and the pipeline circuitry includes a shared resource, the method further comprising:
assigning a first portion of the shared resource to the first group and a second portion of the shared resource to the second group in response to determining that the first group has a higher priority than the second group.

11. The method of claim 8, wherein the pipeline circuitry includes a front fixed-function portion, a programmable shader portion, and a back fixed-function portion.

12. The method of claim 8, further comprising interleaving work from the first group and the second group sent to a fixed-function pipeline portion of the pipeline circuitry.

13. The method of claim 8, wherein the configuration information includes one or more of: an indication of a location of a shader program, an indication of a location of a texture, an indication of a memory space, or state information.

14. A non-transitory computer readable storage medium having stored thereon design information that specifies a design of at least a portion of a hardware integrated circuit in a format recognized by a semiconductor fabrication system that is configured to use the design information to produce the circuit according to the design, including:
first storage circuitry and second storage circuitry configured to store configuration information for respective groups of graphics work to be performed by the circuit, wherein the first and second storage circuitry is programmable by the circuit before sending corresponding groups of graphics work to pipeline circuitry;
pipeline circuitry configured to perform graphics processing operations on groups of graphics work based on configuration information stored in an indicated one of the first storage circuitry and the second storage circuitry;
wherein the circuit is configured to simultaneously store configuration information for first and second groups of graphics work in the first and second storage circuitry respectively; and
wherein the pipeline circuitry is configured to pipeline processing of the first and second groups of graphics work such that data for both groups is processed in different stages of the pipeline circuitry during a given clock cycle, based on configuration information stored in the first and second storage circuitry respectively.

15. The non-transitory computer readable storage medium of claim 14, wherein the second group is older than the first group, the first group has a higher priority than the second group, and the pipeline circuitry is configured to pause processing for the second group until completion of the first group.

16. The non-transitory computer readable storage medium of claim 14, wherein the second group is older than the first group, the first group has a higher priority than the second group, and the pipeline circuitry includes a shared resource; and
wherein the circuit is configured to assign a first portion of the shared resource to the first group and a second portion of the shared resource to the second group in response to determining that the first group has a higher priority than the second group.

17. The non-transitory computer readable storage medium of claim 16, wherein the shared resource is a programmable shader.

18. The non-transitory computer readable storage medium of claim 14, wherein the pipeline circuitry includes a front fixed-function portion, a programmable shader portion, and a back fixed-function portion.

19. The non-transitory computer readable storage medium of claim 18, wherein the back fixed-function portion is configured to perform graphics processing based on configuration information in both the first storage circuitry and the second storage circuitry at the same time.

20. The non-transitory computer readable storage medium of claim 14, wherein the configuration information includes one or more of: an indication of a location of a shader program, an indication of a location of a texture, an indication of a memory space, or state information.
